(19) United States
(12) Patent Application Publication
(10) Pub. No.: US 2026/0368558 A1
(43) Pub. Date: Nov. 19, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Kawasaki-shi (JP)

(72) Inventor: Yojiro TONOUCHI, Inagi (JP)

(73) Assignee: KABUSHIKI KAISHA TOSHIBA, Kawasaki-shi (JP)

(21) Appl. No.: 19/530,484

(22) Filed: Feb. 5, 2026

(30) Foreign Application Priority Data
May 16, 2025 (JP) 2025-082669

(51) Int. Cl. G06N 5/04; G06N 5/022

(52) U.S. Cl. CPC G06N 5/04; G06N 5/022

(57) ABSTRACT

An information processing apparatus includes a learning unit. The learning unit learns a model that inputs at least first input data among the first input data containing reference data and question information indicating a question related to the reference data and second input data not containing the reference data but containing the question information and that outputs output data containing an inference result indicating an answer to the question by using first learning data containing at least description information describing a feature of the reference data, the question information, and a correct-answer information indicating a correct answer.

### CROSS-REFERENCE TO RELATED APPLICATIONS

This application is based upon and claims the benefit of priority from Japanese Patent Application No. 2025-082669, filed on May 16, 2025; the entire contents of which are incorporated herein by reference.

### FIELD

Embodiments described herein relate generally to an information processing apparatus, an information processing method, and a computer program product.

### BACKGROUND

A technique called a visual question answering (VQA) system has been proposed. In the VQA system, a model called a visual language model (VLM) may be used. The VQA system involves in many fields such as computer vision, natural language processing, and knowledge representation (KR), and is becoming a hotspot in artificial intelligence study. The VQA system can answer a question regarding a given image. That is, the VQA system inputs an image and a question regarding the image, and generates and outputs an answer in a natural language with respect to the question.

The VQA system is implemented commonly based on a supervised machine learning method. A large number of learning images and questions and answers related to the learning images are used as learning data for machine learning. This enables a learned (trained) model to answer an input question based on image contents.

### BRIEF DESCRIPTION OF THE DRAWINGS

FIG. 1 illustrates an example of a natural image, which is a still image;

FIG. 2 illustrates an inference process of a VQA task;

FIG. 3 illustrates an inference process of a QA task;

FIG. 4 illustrates an example of a learning process;

FIG. 5 illustrates the example of the learning process;

FIG. 6 is a block diagram of an information processing apparatus of an embodiment;

FIG. 7 is a flowchart of learning processing in the embodiment; and

FIG. 8 is a hardware configuration diagram of the information processing apparatus of the embodiment.

### DETAILED DESCRIPTION

According to an embodiment, an information processing apparatus includes one or more hardware processors configured to function as a learning (training) unit. The learning (training) unit is configured to execute learning (training) of a model that inputs at least first input data among the first input data containing reference data and question information indicating a question related to the reference data and second input data not containing the reference data but containing the question information and that outputs output data containing an inference result indicating an answer to the question by using first learning data containing at least description information describing a feature of the reference data, the question information, and a correct-answer information indicating a correct answer.

A preferred embodiment of an information processing apparatus according to the disclosure will be described in detail below with reference to the accompanying drawings. The present disclosure is not limited to the following embodiments.

A processing load is required for data collection and a processing load is required for calculation of model learning in a technique of learning a model by preparing a large amount of learning data of a specific field in order to create a VQA system to be applied to the specific field. Thus, in many cases, a general-purpose model is learned by using collected learning data of the specific field based on a general-purpose model of VQA learned by using a public and common image data set, and used as a model for the specific field. A technique of applying a general-purpose model to a specific field is called fine tune learning, fine tuning, or the like. Processing loads on data collection and calculation related to image data can be reduced by minimizing the number of pieces of image data necessary for learning in application to the specific field.

Even with the above-described efforts, a large number of actual images are necessary for enhancing the accuracy of an answer. When a large number of actual images are necessary for learning, a load of collecting the actual images is increased. Furthermore, because a data amount per image is larger than, for example, a data amount per text data, a load of calculation for processing an image is increased.

Note that, in the VQA system, for example, information indicating a question (question information) regarding an image (image data) is input to a model. In this example, data (reference data) referred to by the question input to the model is image data. The reference data is not limited to the image data, and may be data in any other format. For example, the reference data may be at least a part of image data, video data, voice data, sound data, point cloud data, and text data (character string data). The image data may be a still image or a moving image. The point cloud data may be two-dimensional point cloud data (2D point cloud data) or three-dimensional point cloud data (3D point cloud data). An example in which the embodiment is applied to a VQA system using image data as reference data will be mainly described below.

The information processing apparatus of the embodiment uses learning data containing a sentence describing an image (image descriptive sentence) instead of the image. The image descriptive sentence is an example of description information describing a feature of the reference data (image data). This can reduce a processing load related to learning of a model used by the VQA system or the like. Note that a model used by the VQA system may be hereinafter referred to as a VQA model.

The embodiment can be applied to, for example, fine tuning in which a general-purpose VQA model learned by using a common image data set is applied to a specific field. In learning of the general-purpose VQA model, learning data containing an image and an image descriptive sentence for the image is used.

The general-purpose VQA model may be learned such that feature information (internal expression) indicating a feature of image data is generated from the input image data and an answer is output by using the generated internal expression and a question. Such a VQA model can be learned by using learning data containing an image descriptive sentence such that the image descriptive sentence functions as a substitute for an internal expression and an appropriate answer to a question is output.

For example, when input image data indicates a flowchart, the internal expression is text data representing the flowchart in the Mermaid format. When input image data indicates a table, the internal expression is text data representing the contents of the table in a comma separated values (CSV) format. When input image data is a natural image, the internal expression is text data indicating a subject contained in the natural image.

An image descriptive sentence used instead of an image is represented in a format similar to that of an internal expression as described above. For example, an image descriptive sentence of image data indicating a flowchart is text data in the Mermaid format. An image descriptive sentence of image data indicating a table is text data in the CSV format, for example. An image descriptive sentence of a natural image is text data indicating a subject contained in the natural image, for example.

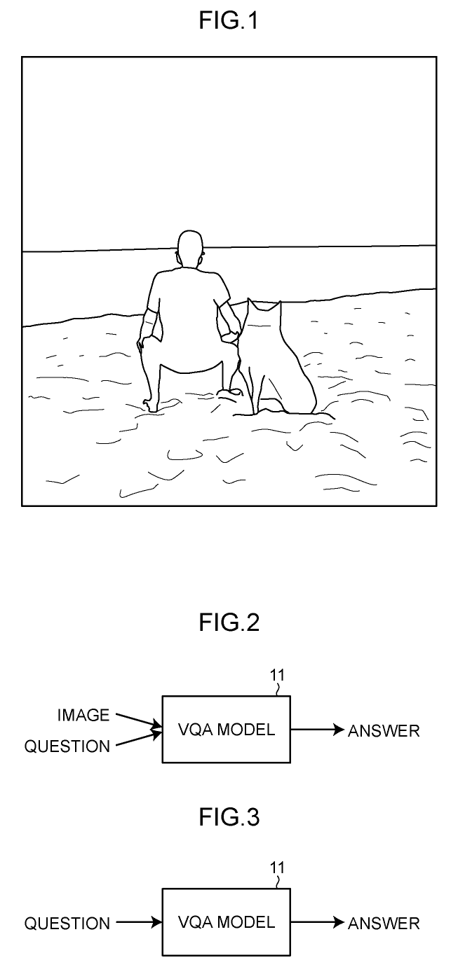

FIG. 1 illustrates an example of a natural image, which is a still image. An image descriptive sentence for the natural image in FIG. 1 is, for example, a sentence "A man and a cat are sitting on a beach".

When reference data other than a still image is used, description information describing a feature of the reference data contains, for example, information as follows.
Voice data: utterance text, stage directions
2D point cloud data: sentence describing object of point cloud data
3D point cloud data: sentence describing object of point cloud data
Moving image: stage directions
Text data: sentence indicating abstract of text data

Next, a configuration example of a VQA model applicable to the embodiment will be described. FIGS. 2 and 3 are schematic diagrams illustrating an example of an inference environment based on the VQA model (VQA system). The VQA model includes two inference processes of a VQA task and a QA task. FIG. 2 illustrates the inference process of a VQA task. FIG. 3 illustrates the inference process of a QA task.

As illustrated in FIG. 2, in the inference process of a VQA task, an image (V) and a question (Q) are input to a VQA model 11 to generate an answer (A). As illustrated in FIG. 3, in the inference process of a QA task, the question (Q) is input to the VQA model 11 to generate the answer (A). The VQA model 11 executes at least the VQA task. The VQA model 11 may execute not only the VQA task but the QA task.

That is, the VQA model 11 inputs at least input data IDA of the input data IDA (first input data) and input data IDB (second input data), and outputs output data. The input data IDA contains image data and question information. The input data IDB does not contain image data, but contains question information. The output data contains an inference result indicating an answer to a question.

The VQA model 11 used in the embodiment may generate feature information (internal expression) indicating a feature of image data as described above. That is, when the input data IDA is input, the VQA model 11 may generate feature information of image data from the image data contained in the input data IDA, and output output data by using the feature information.

Two types of types T1 and T2 are defined below as the VQA model 11.
Type T1: model capable of addressing inference of both VQA task and QA task
Type T2: model capable of addressing inference of only VQA task

The VQA model 11 of the type T1 corresponds to a model of outputting output data both in a case where the input data IDA is input and a case where the input data IDB is input. The VQA model 11 of the type T2 corresponds to a model of outputting output data in the case where the input data IDA is input.

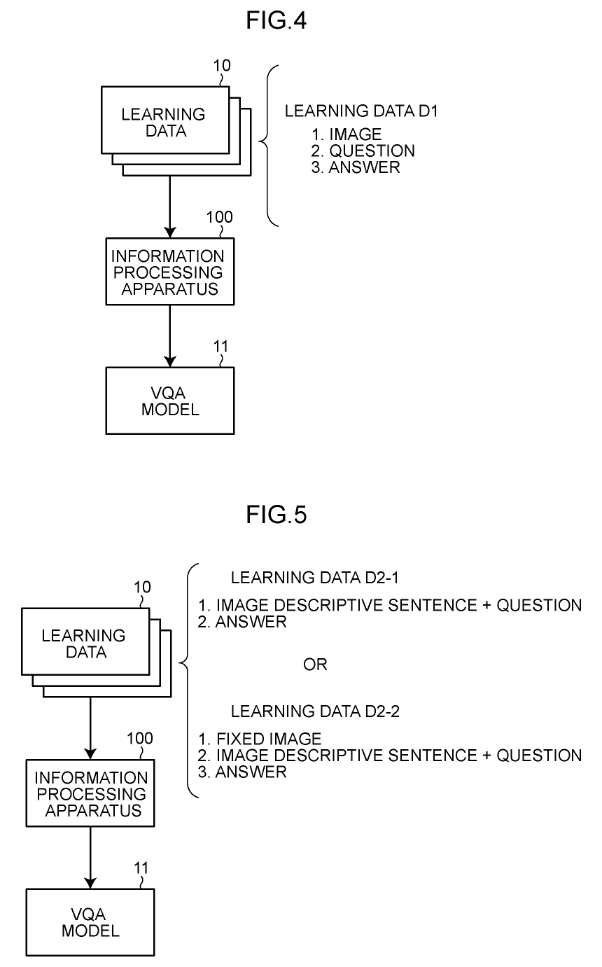

FIGS. 4 and 5 are schematic diagrams illustrating an example of a learning environment of the VQA model 11. The learning environment indicates a learning process of the VQA model 11. The learning environment includes an information processing apparatus 100. The information processing apparatus 100 learns the VQA model 11 for the VQA task by using a learning data set 10.

FIG. 4 illustrates an example of a learning process in a case where the VQA model 11 is learned by using learning data D1 not containing an image descriptive sentence but containing an image. As illustrated in FIG. 4, the learning data D1 in this case contains an image, a question, and an answer.

FIG. 5 illustrates an example of a learning process in a case where the VQA model 11 is learned by using learning data D2 (pieces of learning data D2-1 and D2-2) containing an image descriptive sentence. As illustrated in FIG. 5, the learning data D2 containing an image descriptive sentence can have two patterns of pieces of learning data D2-1 and D2-2. The learning data D2-1 does not contain an image but contains an image descriptive sentence, a question, and an answer. The learning data D2-2 contains a fixed image, an image descriptive sentence, a question, and an answer. For example, the fixed image is preliminarily determined independently of an image whose feature is described by an image descriptive sentence.

As described above, the VQA model 11 can learn the relation between corresponding input and output by using learning data (learning environment in FIGS. 4 and 5). Furthermore, after the learning is completed, the VQA model 11 can generate output corresponding to given input (inference environment in FIGS. 2 and 3).

The learning environment in FIG. 4 corresponds to an environment using learning data containing an image (image data). Therefore, for example, when application is made to fine tuning learning, a processing load on collecting a large amount of learning data in a specific field and a calculation load caused by using an image having a large data amount can be excessive. Thus, the embodiment can achieve the learning environment in FIG. 5 using learning data containing an image descriptive sentence.

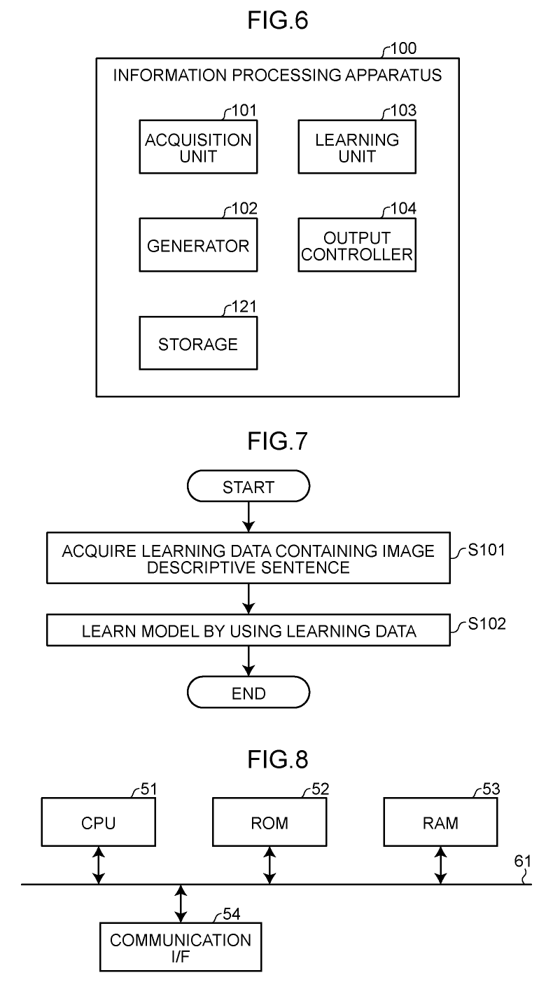

Next, a configuration example of the information processing apparatus 100 that learns the VQA model 11 as described above will be described. FIG. 6 is a block diagram illustrating an example of a configuration of the information processing apparatus 100 of the embodiment. As illustrated in FIG. 6, the information processing apparatus 100 includes an acquisition unit 101, a generator 102, a learning unit 103, an output controller 104, and a storage 121.

The acquisition unit 101 acquires various pieces of information to be used by the information processing apparatus 100. For example, the acquisition unit 101 acquires learning data used for learning of the VQA model 11. Any method may be used as a method of the acquisition unit 101 acquiring information. For example, a method of reception from an external device via a network and a method of reading information from a storage medium can be applied.

The generator 102 generates an image descriptive sentence (description information) used as learning data. For example, the generator 102 generates an image descriptive sentence (description information) from image data. Any method may be used as a method of generating an image descriptive sentence from image data. For example, the generator 102 may use a method of causing generative artificial intelligence (AI) to generate an image descriptive sentence by inputting, to the generative AI, a prompt for giving an instruction to generate an image descriptive sentence for input image data. When an image descriptive sentence is prepared (e.g., when image descriptive sentence is manually generated), the generator 102 is not required to be provided.

The learning unit 103 learns the VQA model 11. In the embodiment, the learning unit 103 learns the VQA model 11 by using learning data TDA (first learning data) containing at least an image descriptive sentence for image data, question information, and correct-answer information indicating a correct answer.

The VQA model 11 to be learned based on the learning data TDA is, for example, a general-purpose model learned by using a common image data set. Furthermore, the learning data TDA corresponds to learning data prepared for fine tune learning for a specific field.

The learning unit 103 may execute learning using a common image data set as learning data in order to further improve the functions as a general-purpose model. For example, the learning unit 103 learns the VQA model 11 by using learning data TDB (second learning data) containing image data, question information, and correct-answer information.

The learning unit 103 may alternately execute fine tune learning (first learning) using the learning data TDA and learning (second learning) using the learning data TDB. The learning unit 103 may execute both in combination. For example, the learning unit 103 may learn the VQA model 11 by using the learning data TDA and the learning data TDB, that is, learning data containing both the learning data TDA and the learning data TDB.

Any technique that is conventionally used may be used as a technique of the learning unit 103 learning the VQA model 11. For example, the learning unit 103 may use a technique of learning the VQA model 11 so as to update some of parameters of the VQA model 11. For example, the following techniques can be applied as the above-explained techniques.
The VQA model 11 is learned such that a parameter PA (first parameter) among parameters of the VQA model 11 is fixed and a parameter PB (second parameter) other than the parameter PA is updated.
The VQA model 11 is learned by a technique based on low rank adaptation (LoRA).

The output controller 104 controls output of various pieces of information used by the information processing apparatus 100. For example, the output controller 104 outputs information (e.g., parameter) on the learned VQA model 11 to an external device using the VQA model 11. Any method may be used as a method of outputting information. For example, a method of displaying on a display device and a method of transmitting information to an external device via a network can be applied.

One or more processing units may implement at least some of the above-described units (the acquisition unit 101, the generator 102, the learning unit 103, and the output controller 104). For example, one or a plurality of processors implements each of the above-described units. For example, each of the above-described units may be implemented by causing a processor, such as a central processing unit (CPU) and a graphics processing unit (GPU), to execute a program, that is, software. Each of the above-described units may be implemented by a processor such as a dedicated integrated circuit (IC), that is, hardware. Each of the above-described units may be implemented by using software and hardware in combination. When a plurality of processors is used, each of the processors may implement one of the units, or may implement two or more of the units.

The storage 121 stores various pieces of information used by the information processing apparatus. For example, the storage 121 stores acquired learning data and information (e.g., parameter) on the VQA model 11 obtained by learning.

Note that the storage 121 can include all commonly used storage media such as a flash memory, a memory card, a random access memory (RAM), a hard disk drive (HDD), and an optical disk.

The information processing apparatus 100 may physically include one device, or may physically include a plurality of devices. For example, the information processing apparatus 100 may be constructed in a cloud environment. Furthermore, each of the units in the information processing apparatus 100 may be distributed and provided in a plurality of devices.

Next, processing of learning the VQA model 11 executed by the information processing apparatus 100 of the embodiment will be described. FIG. 7 is a flowchart illustrating an example of the learning processing in the embodiment.

The acquisition unit 101 acquires learning data containing an image descriptive sentence (Step S101). When the generator 102 generates an image descriptive sentence, the acquisition unit 101 may acquire image data for which an image descriptive sentence is to be generated. In this case, the generator 102 generates the image descriptive sentence from the acquired image data. Learning data containing the generated image descriptive sentence is used for subsequent learning of the VQA model 11.

The learning unit 103 learns the VQA model 11 by using the learning data (Step S102). The output controller 104 may output data of the VQA model 11 obtained by the learning to an external device.

The processing of learning the VQA model 11 will be further described. As described above, in the embodiment, a learning environment as illustrated in FIG. 5 can be achieved. In the learning environment of FIG. 5, the learning data set 10 can contain the following two types of learning data.
Learning data D2-1: sentence (V'+Q) obtained by combining image descriptive sentence (V') for image (V), which is input in inference processing, with question (Q) and answer (A) corresponding to output in inference processing
Learning data D2-2: fixed image (Vc), sentence (V'+Q) obtained by combining image descriptive sentence (V') for image (V), which is input in inference processing, with question (Q) and answer (A) corresponding to output in inference processing

For example, even when image data is not input, the learning data D2-1 can be used in a case where the VQA model 11 capable of outputting an answer to a question related to an image is learned. Such a VQA model 11 is, for example, a VQA model 11 of type T1.

The learning data D2-2 can be used in a case where the VQA model 11 that needs input of image data is learned. Such a VQA model 11 is, for example, a VQA model 11 of the type T2.

The fixed image (Vc) contained in the learning data D2-2 is always the same image, and contains a fixed pixel value like, for example, a black image does. Even when image data having a large data amount is used, a calculation load for the image data can be reduced by using an image having a fixed pixel value. For example, a processing result for a fixed image can be repeatedly used in the subsequent processing, so that the calculation load can be reduced as a whole. In contrast, the fixed image enables execution of learning without an influence on inference based on the VQA model 11.

As described above, the learning unit 103 may be configured to further execute learning using a common image data set as learning data. That is, in the embodiment, learning may be executed in a learning environment as illustrated in FIG. 4.

Therefore, one of the learning data D1, the learning data D2-1, and the learning data D2-2 may be used for, for example, the VQA model 11 of the type T1. Furthermore, one of the learning data D1 and the learning data D2-2 may be used for, for example, the VQA model 11 of the type T2.

The VQA model 11 learned by using an image descriptive sentence enables inference with higher accuracy by being configured to execute inference using an image descriptive sentence. For example, the VQA model 11 may be configured to generate an image descriptive sentence (description information) from image data contained in input input data IDA (input data containing image data and question information) and output output data by further using the generated image descriptive sentence.

The VQA model 11 may be configured to receive input (e.g., prompt) for giving an instruction to generate an image descriptive sentence and generate the image descriptive sentence in accordance with the received input. A user or the like may input the instruction. The instruction may be generated and input inside the VQA model 11 regardless of input given by the user or the like.

As described above, the information processing apparatus of the embodiment can reduce a processing load related to learning of a model used by the VQA system or the like.

Next, a hardware configuration of the information processing apparatus of the embodiment will be described with reference to FIG. 8. FIG. 8 is an explanatory diagram illustrating a hardware configuration example of the information processing apparatus of the embodiment.

The information processing apparatus of the embodiment includes a control device, a storage device, a communication I/F 54, and a bus 61. The control device includes a central processing unit (CPU) 51. The storage device includes a read only memory (ROM) 52 and a random access memory (RAM) 53. The communication I/F 54 is connected to a network to perform communication. The bus 61 connects the units with each other.

A program to be executed by the information processing apparatus of the embodiment is provided by being preliminarily incorporated in the ROM 52 or the like.

The program to be executed by the information processing apparatus of the embodiment may be provided as a computer program product by being recorded in a computer-readable recording medium, such as a compact disk read only memory (CD-ROM), a flexible disk (FD), a compact disk recordable (CD-R), and a digital versatile disk (DVD), in a file in an installable or executable format.

Moreover, the program to be executed by the information processing apparatus of the embodiment may be provided by being stored on a computer connected to a network such as the Internet and downloaded via the network. Furthermore, the program to be executed by the information processing apparatus of the embodiment may be provided or distributed via a network such as the Internet.

The program to be executed by the information processing apparatus of the embodiment can cause a computer to function as each unit of the information processing apparatus described above. In the computer, the CPU 51 can read a program from a computer-readable storage medium onto a main storage device, and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
one or more hardware processors configured to:
execute first learning of a model by using first learning data, the model is a model that inputs at least first input data among the first input data and second input data and that outputs output data, the first data containing reference data and question information indicating a question related to the reference data, the second input data not containing the reference data but containing the question information, the output data containing an inference result indicating an answer to the question, the first learning data containing at least description information describing a feature of the reference data, the question information, and a correct-answer information indicating a correct answer.

2. The information processing apparatus according to claim 1, wherein
the model is a model that generates feature information indicating the feature of the reference data from the reference data contained in the first input data and outputs the output data by using the feature information when the first input data is input.

3. The information processing apparatus according to claim 1, wherein
the model is a model that outputs the output data both when the first input data is input and when the second input data is input.

4. The information processing apparatus according to claim 1, wherein
the model is a model that outputs the output data when the first input data is input.

5. The information processing apparatus according to claim 1, wherein
the reference data is at least a part of image data, voice data, point cloud data, and text data.

6. The information processing apparatus according to claim 1, wherein
the one or more hardware processors are further configured to:
execute second learning of the model by using second learning data containing the reference data, the question information, and the correct-answer information, and
alternately execute the first learning and the second learning.

7. The information processing apparatus according to claim 1, wherein
the one or more hardware processors are configured to execute the first learning of the model by using second learning data containing the reference data, the question information, and the correct-answer information together with the first learning data.

8. The information processing apparatus according to claim 1, wherein
the one or more hardware processors are configured to:
generate the description information from the reference data.

9. The information processing apparatus according to claim 1, wherein
the one or more hardware processors are configured to execute the first learning of the model such that a partial parameter of parameters of the model is updated.

10. The information processing apparatus according to claim 9, wherein
the one or more hardware processors are configured to execute the first learning of the model such that a first parameter of the parameters of the model is fixed and a second parameter other than the first parameter is updated.

11. The information processing apparatus according to claim 9, wherein
the one or more hardware processors are configured to execute the first learning of the model by a technique based on low rank adaptation (LoRA).

12. The information processing apparatus according to claim 1, wherein
the model generates the description information from the reference data contained in the first input data that is input, and outputs the output data by further using the description information that is generated.

13. An information processing method to be executed by an information processing apparatus, the method comprising:
executing first learning of a model by using first learning data, the model is a model that inputs at least first input data among the first input data and second input data and that outputs output data, the first data containing reference data and question information indicating a question related to the reference data, the second input data not containing the reference data but containing the question information, the output data containing an inference result indicating an answer to the question, the first learning data containing at least description information describing a feature of the reference data, the question information, and a correct-answer information indicating a correct answer.

14. A computer program product having a non-transitory computer readable medium including instructions stored thereon, wherein the instructions, when executed by a computer, cause the computer to execute:
first learning of a model by using first learning data, the model is a model that inputs at least first input data among the first input data and second input data and that outputs output data, the first data containing reference data and question information indicating a question related to the reference data, the second input data not containing the reference data but containing the question information, the output data containing an inference result indicating an answer to the question, the first learning data containing at least description information describing a feature of the reference data, the question information, and a correct-answer information indicating a correct answer.
